(19) United States
(12) Patent Application Publication
(10) Pub. No.: US 2015/0353394 A1
(43) Pub. Date: Dec. 10, 2015

(54) System and Method for Treating Wastewater

(71) Applicant: NCH Corporation, Irving, TX (US)

(72) Inventors: Scott M. Boyette, Irving, TX (US); John L. Knope, Flower Mount, TX (US); William P. Boesch, Dallas, TX (US); Bob Pearce, Arlington, TX (US)

(21) Appl. No.: 14/535,045

(22) Filed: Nov. 6, 2014

Related U.S. Application Data
(60) Provisional application No. 62/008,320, filed on Jun. 5, 2014.

(51) Int. Cl. C02F 3/00; C02F 3/02

(52) U.S. Cl. CPC C02F 3/006; C02F 3/02; C02F 2209/003

(57) ABSTRACT

A system and method of treating wastewater within a wastewater network, such as a sewer system, to control odor (primarily from sulfides and H₂S), FOG (fats, oil, and grease), and corrosion in a distributed wastewater or sewer system. The system and method comprise generating bacteria using an on-site biogenerator, feeding the bacteria into the wastewater, mixing the wastewater and adding oxygen with an aerator/mixer to maintain dissolved oxygen levels of at least 0.5 ppm (if needed), and adding supplemental treatment chemicals (if needed). The system and method preferably comprise monitoring the wastewater and controlling feed rates of bacteria, oxygen and supplemental chemicals based on the results of monitoring.

### CROSS-REFERENCE TO RELATED APPLICATION

This application claims the benefit under 35 U.S.C. §119(e) of U.S. Provisional Application Ser. No. 62/008,320 filed on Jun. 5, 2014.

### BACKGROUND OF THE INVENTION

1. Field of the Invention

This invention relates to a system and method for treating wastewater, such as water flowing into or through a municipal sewer system, using a biogenerator to feed bacteria into the wastewater system and an optional aerator/mixer to mix and add oxygen to the wastewater.

2. Description of Related Art

Municipal sewer systems typically involve a series of wastewater pipes that carry wastewater from households and commercial and industrial facilities to a treatment plant. Much of the wastewater is transported through the pipes by gravity flow; however, pumping of the wastewater is typically required in at least some locations throughout the sewer system. Wastewater from a portion of the system will feed into a lift station or pumping station, where it fills a reservoir until a certain water level is reached at which point pumps are activated to pump out the reservoir, sending the wastewater downstream through the sewer system towards the treatment plant. Typically a sewer system will include many lift stations.

Lift stations are known to have several problems, including hydrogen sulfide and grease caps created by mixed fats, oils, and greases (FOG) within the lift station. Hydrogen sulfide in lift stations and sewer networks poses several problems to the systems and the workers who have to work near or in the system. The H₂S is noxious, presents serious health concerns, and can create metal and concrete corrosion issues that degrade the physical systems over time.

One common way to treat H₂S in sewer systems is to feed an oxidant like hypochlorite, ozone, or other chemical oxidants that oxidize the H₂S to sulfate. Another common treatment is to feed calcium nitrate that reacts with H₂S and provides additional oxygen that slows the H₂S generating bacteria in biofilm. There are additional refinements to this technology. For example, U.S. Pat. No. 7,186,341 discloses treating wastewater with a nitrate containing compound and an alkaline material, as the addition of the alkaline material reduces the amount of nitrate needed to effectively treat the wastewater. Additionally, U.S. Pat. Nos. 7,553,420, 7,972,532, and 7,285,217 disclose a treatment composition having a nitrate salt, sulfide consuming compound, and a pH elevating reagent to control odor in waste products. This composition may be used alone or combined with 0.1-1 part of a nitrate reducing or sulfide oxidizing bacteria (such as Thiobacillus dentrificans) or enzymes produced by those bacteria in order to seed the system with bacteria or enzymes that act as sulfide reducers or enzymes that catalyze specific metabolic pathways. U.S. Pat. Nos. 7,087,172 and 7,285,207 also disclose a closed-loop system for controlling the feed of these chemicals by using a downstream monitor to provide feedback for chemical feed. Other known treatments include adding quinones and metallic nitrogen oxide to systems containing sulfate reducing or H₂S metabolizing bacteria, such as in U.S. Pat. Nos. 5,500,368, and 6,309,597.

Grease caps are also known to form in lift stations. The FOGs in the wastewater accumulate on the surface of the water in the lift station's reservoir and can form a thick covering over the water known as a grease cap. Grease caps are known to interfere with the level sensors in the lift station, clog pumps, and increases the frequency of necessary cleanings. Typically, grease caps are treated with degreasers and chemical treatments or are physically removed by washing down the reservoir.

It is also known to modify the bacterial population within a wastewater system through competitive exclusion to enhance treatment of the wastewater. For example, U.S. Pat. No. 8,828,229 discloses a system for decreasing hydraulic loads at a downstream wastewater treatment plant and adding bioaugmentation bacteria using strategically located membrane biological reactor/biological breeding reactor (“MBR/BBR”) units at various points within a sewer system, such as at multiple lift stations upstream of the treatment plant. The MBR/BBR units dewater wastewater from a lift station using a membrane to separate out usable water, which is then diverted out of the sewer system for other uses, to reduce the hydraulic load at the treatment plant. The MBR/BBR units are also supplied with bacteria and nutrients to grow bacteria for bioaugmentation purposes. The bacteria grown in the unit are periodically discharged to the lift station. The units cycle between periods of dewatering and periods of bacteria growth. The membrane technology used in the MBR/BBR units can be expensive to maintain and requires maintenance and cleaning of the membrane. The use of the MBR/BBR system in the '229 patent also requires several pumps, including one to feed wastewater into the MBR/BBR unit from a lift station, to backwash the membrane, to deliver bacteria and nutrients to the membrane tank, and other equipment, such as screens to prevent the MBR/BBR unit from being clogged. This equipment adds to the complexity of the treatment system, the capital and maintenance costs of the system, and results in additional downtime for maintenance. Additionally, the bacteria growth tank in the MBR/BBR unit is also used to receive wastewater from the lift station for dewatering, which would result in contamination with bacteria from the wastewater and reduce the effectiveness of the bioaugmentation process.

The use of chemicals to treat wastewater may have a detrimental impact on the biological treatment systems used downstream in the treatment plant. They can also be harmful to workers administering the treatment and to components of the sewer system. There is a need to effectively treat wastewater without the use of such chemicals or with a significant reduction in the use of such chemicals. There is also a need for a system and method utilizing bioaugmentation to enhance wastewater treatment using a simple biogenerator that can rely on gravity feed to avoid the need for additional pumping equipment and that avoids prior art contamination issues resulting from wastewater flowing through the biogenerator.

### SUMMARY OF THE INVENTION

This invention provides a system and method to treat wastewater systems and is particularly useful in treating wastewater in municipal sewer systems. The system and method control odor (primarily sulfides and H₂S), FOG, and corrosion in a distributed sewer system by using one or more on-site biogenerators to feed bacteria into the wastewater system. In one preferred embodiment, a biogenerator feeds bacteria into a lift station to change the biological consortia in biofilms within the lift station reservoir and in downstream sewer lines, particularly forced mains, from anaerobic (which produces H₂S) to aerobic. In another preferred embodiment, a biogenerator is used in combination with an aeration/mixing system. The aeration/mixing system is preferably added to one or more lift stations to increase oxygen levels above 0.5-ppm (if needed) to support aerobic bacterial growth. In yet another preferred embodiment, supplemental chemicals can be added, in combination with the biogenerator alone or with both the biogenerator and aerator/mixer. These supplemental chemicals may aid in reducing H₂S, if needed, but would be used at much lower concentrations than currently practiced in the industry. The system would reduce concerns with H₂S odor, corrosion and grease build-up, while having minimal impact on the downstream treatment plant.

In yet another preferred embodiment, the system and method of the invention also comprises a monitoring system to test the wastewater at various locations for levels of H₂S, corrosion, and dissolved oxygen, for example. Another preferred embodiment of the invention, the system and method comprise a control system for automatically adjusting operating parameters of various components of the system. Such adjustment may be carried out by a timing mechanism, or automatically based on data or signals received by a controller from an automated monitoring system, or may be carried out through manual inputs to a controller based on data or test results obtained through the monitoring system.

The systems and methods of the invention enhance control of common sewer system and lift station problems through strategically placing components of the treatment system within the sewer network so that bacteria, alone or in combination with oxygen/mixing, are delivered to key and problematic lift stations to treat the majority of the wastewater flow. By varying the placement of treatment components within the sewer system relative to the problematic lift stations, feedforward or feedback control is possible. By evaluating the system and networking units, it is possible to control a large branched sewer system using minimal equipment and all natural products. There may in some cases be a need for supplemental chemical feed, but at much lower concentrations than normally required, and possibly just short term. Additionally, the treatment system utilizes common soil bacteria that are common to sewer systems and treatment plants and do not interfere with downstream processes.

### BRIEF DESCRIPTION OF THE DRAWINGS

The system and method of the invention is further described and explained in relation to the following drawings wherein:

FIG. 1 is a schematic view of a sewer system showing placement throughout the sewer system of components of a treatment system according to one preferred embodiment of the invention;

FIG. 2 is schematic view of an embodiment of a treatment system according to a preferred embodiment of the invention;

FIG. 3 is a schematic view of a sewer system showing placement at various points throughout the sewer system of components of a treatment system according to one preferred embodiment of the invention;

FIG. 4 is a schematic view of a portion of a sewer system showing placement of a monitoring point according to one preferred embodiment of the invention.

### DESCRIPTION OF THE PREFERRED EMBODIMENTS

A system according to one preferred embodiment of the invention uses at least one on-site biogenerator to feed large concentrations of soil bacteria (10-30 trillion, or more) into a wastewater stream or into a sewer system lift station. The preferred biogenerators to be used with the system are those described in U.S. Pat. Nos. 6,335,191; 7,081,361; 7,635,587; 8,093,040; and 8,551,762, which are incorporated herein by reference, and the commercially available ECOBionics BioAmp™, but other biogenerators may also be used. The preferred soil bacteria include Pseudomonas fluorescens, Pseudomonas putida, Bacillus subtilis (4 strains), Bacillus lichenformis, Bacillus thuringiensis, Bacillus amyloliquefaciens (2 strains), and Bacillus simplex (2 strains), but other types of bacteria may be used as will be understood by those of ordinary skill in the art.

The soil bacteria perform two tasks. First they digest the mixed fats, oils, and greases (FOG's), which reduces the formation of grease caps while assuring mixed FOG is not redeposited downstream. Second, they slowly transform the biofilm in the lift station(s) and sewer lines (particularly forced main lines) over time so that the biofilm becomes aerobic and no longer produces H₂S by anaerobic processes. This reduction in H₂S correlates directly to a reduction in concrete and metal corrosion and public nuisance odors within the networked system.

A system according to another preferred embodiment of the invention includes one or more on-site biogenerators in combination with one or more mixers/aerators. The mixers/aerators are located within the lift stations to mix the water and add oxygen to the water within the lift station's reservoir. The bacteria added to the wastewater may require more dissolved oxygen than is already present in the water system, so the mixer/aerator will provide the additional oxygen needed by the bacteria. The agitation or mixing created by the mixer/aerator also aids in preventing the formation of grease caps. This allows the lift station level detection and pumping systems to work properly. It also greatly reduces required cleanings, which benefits sewer system workers who are required to enter the lift stations to clean them out.

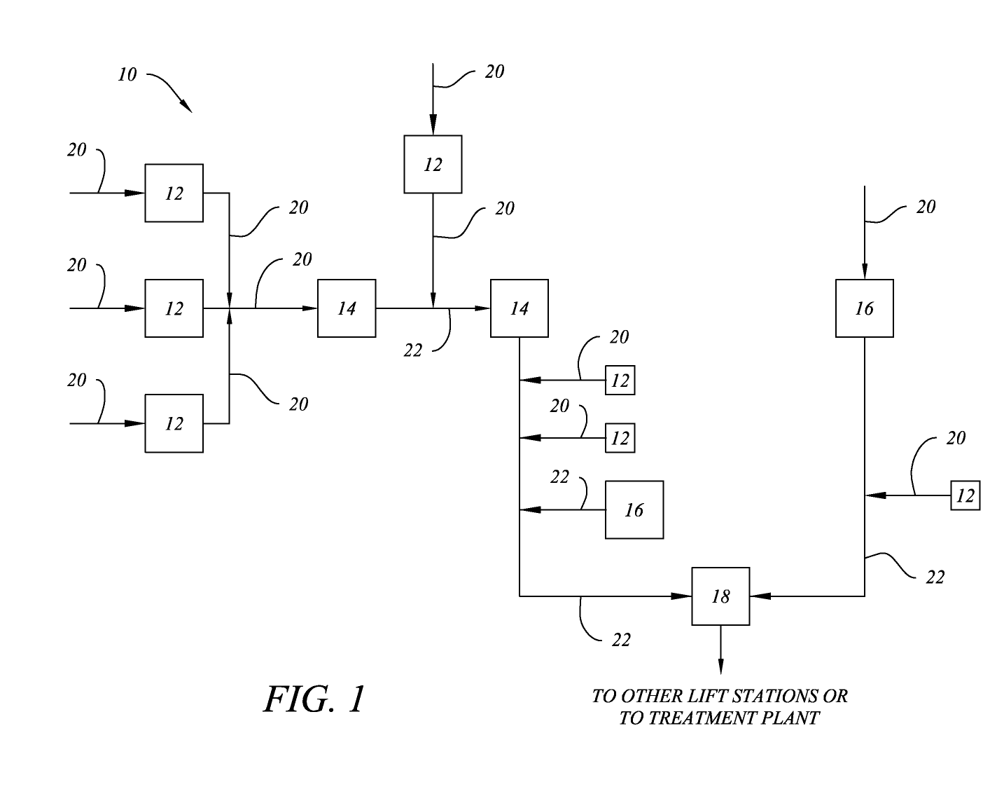

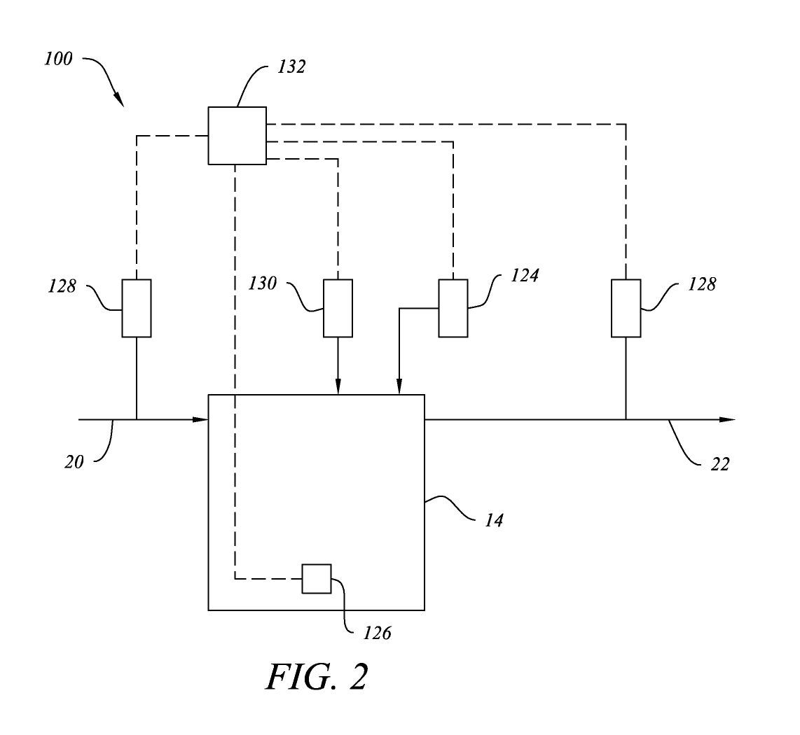

FIGS. 1-2 show a sewer system 10, within which one or more treatment systems 100 according to the invention may be used. Sewer system 10 comprises one or more lift stations 12, 14, 16, and 18. Wastewater 20, that has not been treated with the system or according to the method of the invention, flows from various household and commercial and industrial sources (not depicted) to one or more lift stations. Once a certain level of water has been reached in each lift station, the wastewater 20 is pumped out and flows downstream to the next lift station 12, 14, 16, or 18, and the process is repeated until the wastewater reaches a treatment plant. Lift stations 14, 16, and 18 preferably comprise one or more components of the treatment system 100, as described below in relation to FIG. 2. Wastewater 22, having been treated by a system and method according to an embodiment of the invention, is pumped from lift stations 14, 16, and/or 18 and flows downstream to the next lift station 12, 14, 16, or 18 or to the treatment plant. Sewer system 10 may have one or more lift stations 18 that are considered particularly problematic with respect to H₂S and/or grease caps. Lift stations 14 and 16 are preferably located at various points upstream of a problematic lift station 18, but may also be located downstream of a problematic lift station 18. The arrangement of lift stations 12, 14, 16, and 18 with respect to each other as depicted in FIG. 1 is exemplary only and is not intended to limit the invention claimed herein. The various lift stations 14, 16, and 18 that incorporate one or more components of treatment system 100 may be located throughout the sewer system 10 and in any relationship to other lift stations as needed to achieve the desired level of treatment of the wastewater.

Additionally, the treatment system 100 and methods according to the invention may be used in other wastewater systems, such as industrial pre-treatment facilities and/or located at an outfall where a commercial or industrial wastewater stream feeds into a localized treatment plant or municipal sewer system. The use of the systems and methods according to the invention may help municipal sewer systems and commercial and industrial users meet pre-treatment requirements imposed by governmental entities or regulations, maintain compliance with permits, and reduce wastewater disposal costs.

A preferred embodiment of a wastewater treatment system 100 is depicted in FIG. 2. Treatment system 100 preferably comprises a biogenerator 124 and optionally comprises one or more of a controller 132, mixers/aerators 126, a monitoring system 128, and/or chemical feed systems 130. Wastewater 20 flows into lift station 14, where it is treated by treatment system 100. Once the wastewater in lift station 14 reaches a certain level, it is pumped out of lift station 14 as treated wastewater 22. Treated wastewater 22 then flows downstream to another lift station, which may or may not include various components of treatment system 100, or to a treatment plant.

Biogenerator 124 grows and feeds bacteria into lift station 14. Each biogenerator 124 preferably comprises a feed reservoir, a growth tank, and an inlet connectable to a source of water to supply the growth tank, and is configured to allow gravity feed of the bacteria starter material (and any nutrients and growth substrate) into the growth tank and gravity discharge from the growth tank to the lift station 14 or other discharge point within the wastewater system. The feed reservoir is preferably sized to hold an amount of bacteria starter material sufficient to periodically supply (such as once per day or twice per day) the lift station with bacterial suspension for a period of time, such as two weeks or a month or longer, depending on the rate of discharge desired. Once the bacteria starter material is depleted, the feed reservoir is either refilled or it may be removed and replaced with a new, pre-filled reservoir. The starter bacteria is most preferably in a liquid, powdered, or tablet form, most preferably with nutrients and growth substrate included. Preferred sources of starter bacteria for use with the biogenerator are FREE-FLOW Pellets or FREE-FLOW HC, commercially available from Ecobionics. The starter bacteria, along with nutrients and growth substrate (if not included with the bacteria as an integrated starter material), are periodically added to the growth tank from the feed reservoir, preferably automatically by a dosing system like those in the biogenerator patents listed above.

Most preferably, each biogenerator 124 is connected to a source of water (such as a municipal water line or other relatively clean water source) through an inlet with a valve controlled by a controller to add water to the growth tank according to predetermined cycle times or by manual input to controller. Municipal water, which is supplied under pressure, is most preferred because it has little bacterial contamination and does not require an on-site pump to feed water to the growth tank. Additionally, the water inlet may be configured to discharge the water under pressure within the growth tank in a manner that aids in mixing the water, bacteria starter, nutrient, and growth substrate and aerating the mixture within the growth tank. Water may also be manually added to the growth tank, and the addition of bacteria starter, nutrients, growth substrate, and discharge of the bacteria solution from the growth tank may also be manually controlled.

Biogenerators 124 are preferably temperature controlled using Peltier heaters and convective heat/cool control, but conductive heat/cool control may also be used. The temperature control is designed to heat when the ambient environmental conditions are cool, and cool when they are warm. Temperature control allows the temperature within the growth tank in the biogenerator 124 to be adjusted and maintained at or near an ideal growth temperature for the particular bacteria species being grown. Temperature control may be integrated with the biogenerator 124 or the biogenerator 124 may be housed in a building, shed, cabinet or other structure that is temperature controlled. Housing the biogenerator 124 in such a structure may also help shelter and protect the biogenerator, including providing some insulation from ambient temperature extremes, particularly in colder weather. It is preferred to use some form of housing for the biogenerator to protect it from the weather, even if the biogenerator has integrated temperature control.

The bacteria are allowed to grow inside the growth tank for at least 10 to 36 hours, preferably around 24 hours before being discharged as a bacterial suspension into the lift station or other location within the wastewater system. Most preferably, each biogenerator 124 is sized to discharge around 1 to 100 liters of bacterial suspension per day for each 25,000 to 250,000 gpd of wastewater flow through the lift station (or other point in the wastewater system) at which the biogenerator is located. The bacterial suspension preferably has at least 10⁵ to 10⁷ CFU/ml. The size of the biogenerator 124 may vary depending on the amount of wastewater typically flowing through the lift station or through the entire sewer system feeding a treatment plant. The amount of bacteria fed into lift station 14 may be increased or decreased with changes in the volume of wastewater and/or based on results of testing through monitoring stations 128. Feeding bacteria in excess amounts should not have a detrimental effect on the treatment system 100 or sewer system 10. The use of the preferred biogenerators described herein eliminate most of the pumping and filtering equipment needed with prior art systems and eliminate contamination issues associated with wastewater contacting the growth tank. The biogenerators may also be configured with multiple growth chambers to allow dosing from one growth chamber while bacteria are growing in one or more other growth chambers to enable increased dosing frequency while still providing sufficient growth time.

Treatment system 100 optionally comprises an aerator/mixer 126 that mixes or agitates the water in lift station 14 and adds oxygen. Preferably the dissolved oxygen level within the water is maintained at a level at or above 0.5 ppm, which is considered a safe threshold for aerobic bacterial growth. Most preferably, the aerator/mixer 126 creates a vortex within lift station 14 for mixing and injecting oxygen. Aerator/mixer 126 is preferably located at the bottom of lift station 14 to allow for changes in water level in the lift station and is preferably centrally located in the bottom of lift station 14. Although not required, a central location allows for better oxygen distribution within the water in the lift station. A preferred aerator/mixer is the “Little John Digester” commercially available from DO₂E, but other aerators/mixers may be used.

Treatment system 100 also optionally, but preferably, comprises a monitoring system 128. Monitoring system 128 may comprise a sample port for manually sampling and testing wastewater 20 or 22, but preferably comprises commercially available automated testing equipment. Automated testing equipment may be configured to send data or signals to a controller 132 to carry out adjustments of operating parameters of various components of treatment system 100 or may provide data that is used to manually adjust operating parameters or for manual input into a controller. Any variety of wastewater parameters may be tested with monitoring system 128. Preferably H₂S, corrosion rates, and dissolved oxygen levels are tested at one or more monitoring stations 128 located throughout sewer system 10. As wastewater 20 feeds into lift station 14, it may be sampled or tested by optional monitoring system 128. As treated wastewater 22 exits lift station 14, it may be sampled or tested again by optional monitoring system 128. Although depicted as being located immediately upstream and downstream of lift station 14 in FIG. 2, it is not required to have monitoring systems 128 in these locations, rather monitoring systems may be added at any location and at multiple locations throughout sewer system 10. Monitoring or sampling may occur at upstream and/or downstream manhole locations, at the inlet and outlet of a lift stations, or any other access point within the wastewater system within which treatment system 100 is used. Most preferably, treatment system 100 comprises at least one monitoring station 128 located downstream of the one or more problematic lift stations 18. Data and test results from monitoring systems 128 may be used to define feed rates and feed frequencies (from the biogenerator 124 and chemical feed system 130) and required O₂ addition. These parameters may be manually adjusted based on the information obtained from monitoring systems 128 or, more preferably, are automatically adjusted through controller 132.

Treatment system 100 also optionally comprises a chemical feed system 130. Chemical feed system 130 may be used to add supplemental treatment chemicals to the wastewater in lift station 14. Most preferably, these chemicals would include calcium or sodium nitrate. Chemical feed system 130 preferably comprises a standard chemical storage tank and feed pump (not depicted), but may also be configured for gravity feed. Chemical feed system 130 may be needed for areas where H₂S levels are very high, such as in Lubbock, Tex., where the levels can be around 600 ppm, in order to supplement the bacterial treatment. Supplemental chemical feed may also be needed during peak load periods or during system start-up when biofilm conversion is still in progress. The amount of chemicals that would need to be added in such circumstances is substantially lower when combined with the bacterial treatment system and methods according to the invention than with conventional chemical treatments alone.

Treatment system 100 preferably comprises a controller 132. Controller 132 may be integrated with biogenerator 124 or it may be a separate control system. Controller 132 may be a simple timer mechanism that activates the biogenerator 124, aerator/mixer 126, and/or chemical feed system 130. For example, controller 132 may automatically activate discharge of bacteria from the biogenerator at given time intervals so that a predetermined volume of discharge or quantity of bacteria is fed to lift station 14. More preferably, controller 132 comprises an automated control system that receives data or signals from monitoring systems 128 and automatically activates the biogenerator 124, aerator/mixer 126, and/or chemical feed system 130 in response to that data or signals, in addition to any pre-set time cycle intervals. A controller 132 may be located at each lift station 14, 16, and 18 that includes components of treatment system 100. A centralized controller 132 may also or alternatively be located remotely from lift stations 14, 16, and 18. Controller 132 preferable comprises the ability to receive manual inputs to activate or deactivate any of the components or systems of treatment system 100.

Most preferably, multiple embodiments of treatment system 100 are located throughout the sewer system 10. For example, lift stations 14 on FIG. 1 preferably include biogenerator 124 and aerator/mixer 126 (and optionally other components, as shown in FIG. 2), while other lift stations 16 preferably include biogenerator 124 but do not include aerator/mixer 126. Typically, each lift station 14, 16 being treated will have at least one biogenerator 124 and each problematic lift station 18 will have a monitoring system 128. If needed to increase the amount of bacterial suspension discharged into the lift station, two or more biogenerators 126 may be used with any given lift station 14, 16. Additionally, more than one biogenerator 124 may be used at any given lift station 14, 16 if it is desired to feed different bacteria or different rates. For example, a first biogenerator may be configured to discharge a Bacillus solution once every 12 hours and a second biogenerator may be configured to discharge a solution comprising Bacillus and Pseudomonas once every 24 hours, or any other combination of bacteria used to degrade specific substrates, particularly more recalcitrant materials such as human hormones, steroids, and the like.

Most preferably, the treatment components of system 100 are located at lift stations 14, 16 located upstream in relatively close proximity of problematic lift station 18 and testing of the wastewater is performed with a monitoring system 128 at or near the problematic lift station 18. There may be multiple problematic lift stations 18 within sewer system 10, which may result in treatment both upstream and downstream of any given lift station 18. Additionally, a lift station where components of a treatment system 100 are located (lift stations 14, 16) may also be considered problematic. A monitoring system 128 is preferably located downstream of a lift station 18, but additional monitoring systems 128 may also be located up or downstream of any other lift station 12, 14, or 16 within sewer system 10 to provide data or signals to aid in controlling treatment with one or more treatment systems 100 according to the invention. For odor and corrosion control purposes, it is most preferable that one or more of the lift stations 14, 16 having a biogenerator 124 be located immediately upstream of a forced main. Forced mains are typically single phase flow systems and do not have enough air in the main to maintain sufficient oxygen levels for aerobic bacteria. This leads to the development of anaerobic biofilms that create H₂S and produce the odor. Gravity fed portions of sewer system 10 are generally two phase systems, but can also grow anaerobic biofilms, but this is less common. Although any lift station within sewer system 10 may be selected for placement of components of treatment system 100, it is preferred to locate biogenerators at high flow lift stations that are immediately upstream of a forced main, to achieve the best treatment results. It is also preferable to use an aerator/mixer 126 upstream of a forced main to add oxygen upstream of where there will be little oxygen mixed with the wastewater in the flow lines, but locations upstream of gravity fed sewer lines may also be used.

A method of treating wastewater according to a preferred embodiment of the invention comprises providing one or more biogenerators and one or more aerator/mixers at various locations within a wastewater system upstream of a wastewater treatment plant, preferably a municipal sewer system or similar branched system receiving wastewater flow from various sources and experiencing high levels of H₂S and/or grease cap problems. Most preferably the method uses a combination of treatment systems 100 having different components to treat wastewater in the wastewater system 10. At one of the locations upstream from the wastewater treatment plant, bacteria produced in the biogenerator are fed into the wastewater, most preferably directly into a lift station, and the water is mixed and oxygen added with the aerator/mixer to maintain at least 0.5 ppm dissolved oxygen in the water. Most preferably, bacteria addition, either alone or combined with aeration/mixing, occurs at multiple locations within the wastewater network upstream of a treatment plant.

According to another preferred embodiment, the water is also monitored for H₂S, dissolved oxygen and/or corrosion rates downstream of the treatment and the treatment parameters are modified based on the test results. Monitoring preferably occurs at multiple locations downstream of where a biogenerator is located. Additional monitoring may occur upstream of one or more locations where a biogenerator is located. Monitoring allows to modifications in the addition of bacteria and/or aeration/mixing, such as altering the amount of bacteria added or the timing of bacteria addition to correspond with peak flow conditions, to enhance treatment of the wastewater and improve efficiency of the treatment according to the invention. Supplemental chemical treatments may be added to the water if needed. Monitoring may also be used to determine whether adjustments to supplemental chemicals are need, such as increasing or decreasing the amounts or types of chemicals added. Preferably, one or more controllers are used to control discharge from the biogenerators and activation of the aerator/mixers based on manual inputs, programmed time intervals, and/or in response to data or signals received by the controller from the monitoring/testing of the water. The volume of water flow through the wastewater system and history of locations within the system experiencing problems with H₂S and/or grease caps are used to determine where treatment and monitoring components are located. Preferably the treatment components are located within the wastewater system so that at least 50%, and more preferably at least 80%, of the total wastewater flow in the wastewater system are treated with bacteria from the biogenerator and/or treated with an aerator/mixer.

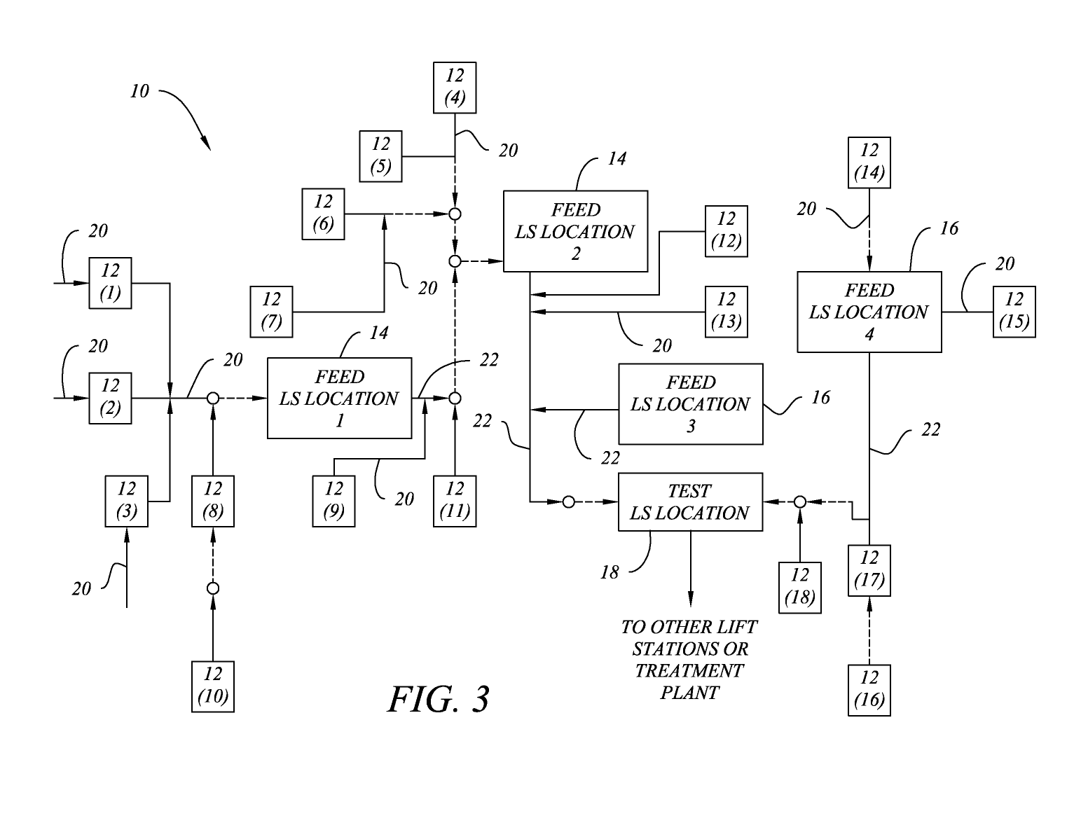

A system and method according to a preferred embodiment of the invention were field tested in a municipal sewer system to control odor (H₂S) and Fats, Oil and Grease (FOG) accumulation. FIG. 3 shows a schematic of the sewer system 10 as used in the field test. FIG. 3 is similar to FIG. 1, but the sewer system depicted has a different layout, as different configurations will be encountered with each sewer system in which treatment systems 100 are used. The particular layout of sewer system 10 and components of treatment systems 100 shown in FIG. 3 is exemplary only and is not intended to limit the invention claimed herein. The representation of the field test sewer system 10 in FIG. 3 shows only a portion of the overall sewer system that was treated with treatment systems 100 according to a preferred embodiment of the invention. Field test sewer system 10 comprises 23 lift stations, a plurality of untreated lift stations 12 (each numbered in parentheses on FIG. 3 as 1-18), two lift stations 14 (labeled as Feed LS Locations 1 and 2) treated with a biogenerator and an aerator/mixer components of treatment system 100, two lift stations 16 (labeled as Feed LS Locations 3 and 4) treated with a biogenerator of treatment system 100 (without an aerator), and a test lift station 18. As with FIG. 1, wastewater 20 feeds into the lift stations and wastewater treated in lift stations 14, 16 or 18 exits those lift stations as treated wastewater 22. Wastewater flow lines shown in FIG. 3 as dotted lines represent segments of the sewer system 10 that are gravity fed and the solid lines represent forced mains. The total flow through the field test sewer system 10 at the downstream lift station 18, where monitoring occurred, was 1 million gallons per day (MGD), on average. Treatment lift stations 14 and 16 were selected for treatment to treat those stations with the higher net flow per day. This treatment location design resulted in approximately 80% of the total flow being treated by aeration/mixing and/or feeding biologicals. The treatment lift stations 14, 16 were also selected so that the immediate downstream flow was a forced main, which tend to have greater levels of H₂S producing anaerobic biofilms that may be converted to aerobic biofilms with components of treatment system 100, but gravity drain sections could also have been treated using the same treatment system 100.

Each treated lift station 14, 16 was fed daily from two temperature controlled biogenerators (such as biogenerators 124) that fed 15-30 trillion bacteria each per day. Two biogenerators were used at each lift station 14, 16 to increase the total amount of bacteria fed to each station, but the use of multiple biogenerators could also be used to feed bacteria solutions from one or more biogenerators that have different bacteria species from the bacteria solutions fed by one or more other biogenerators. The biogenerators used in the field test were all temperature controlled to maintain the temperature between 80 and 90° F. Two treated lift stations 14 also had aeration/mixing systems (similar to aerator/mixer 126 and commercially known as Little Johns). The aerator mixer device sat on the bottom of each lift station 14 and was driven by an air compressor located on the ground next to each lift station 14. A hose connected the compressor to the aerator/mixer stone. The air from the compressor drove the wastewater through the aerator/mixer in lift station 14 and created mixing, while at the same time providing air that oxygenates the fluid within the lift station 14.

The test lift station 18 was the downstream lift station that received the flow from all 22 upstream stations (12, 14, and 16). Test lift station 18 was monitored for H₂S to determine the total system H₂S reduction using the configuration of treatment systems 100 shown in FIG. 3. The H₂S was measured using an odalogger suspended at the inside top of lift station 18 (one type of monitoring system 128 that may be used with treatment system 100). The data from the odalogger was recorded in the device every few minutes, and then downloaded monthly. Daily flow and weekend flow changes made daily analysis noisy, so the data was averaged across a single week. Temperature at the odalogger was recorded and averaged the same way. Table 1 shows the % H₂S reduction produced over 15 weeks, along with the average temperature during this period. The % H₂S reduction is the reduction in H₂S levels using treatment with treatment systems 100 according to preferred embodiments of the invention compared to baseline, pre-field test results without using treatment system 100. The data shows an average 80% H₂S reduction at the test lift station 18, with variance that tracked temperature inside the lift station.

TABLE 1
Test Lift Station Data

| WEEK | % H₂S Reduction | Temperature (° F.) |
|---|---|---|
| 1 | 78.7 | 85 |
| 2 | 83.0 | 86 |
| 3 | 79.4 | 86 |
| 4 | 78.7 | 86 |
| 5 | 76.2 | 86 |
| 6 | 79.7 | 86 |
| 7 | 71.7 | 90 |
| 8 | 69.4 | 88 |
| 9 | 70.3 | 88 |
| 10 | 69.9 | 85 |
| 11 | 83.0 | 84 |
| 12 | 93.0 | 83 |
| 13 | 89.8 | 84 |
| 14 | 89.8 | 82 |
| 15 | 89.5 | 82 |
| Average | 80.1 | 85 |
| Range | 23.5 | 8 |

One of the criteria desired in a sewer network is that there be no odor complaints from residents using or near the sewer system, and there were none during the test period for the field test described above. Additionally, FOG build up in a lift station can cause operational problems from floats and sensors being coated, and this requires the municipalities to wash down the station before servicing, or to assure proper operation. The bacteria fed to the system (FREE-FLOW pellets) through the biogenerators at lift stations 14 and 16 are known FOG degraders, and the field test sewer system 10 responded to treatment and almost all grease caps were eliminated from the all downstream stations. The operators of the field test sewer system 10 shown in FIG. 3 also reported that prior to starting the described treatment, the operators would have to wash down the stations were water was available every one to two weeks. Shortly after starting treatment the municipality reported that they had to wash down Feed LS Location 3 (a station 16, with a biogenerator and without aeration) twice, and that none of the other lift stations required wash downs, and showed no evidence of a grease cap. Reduction in FOG accumulation was also observed further downstream in the field test sewer system at the main lift station that feeds the publically owned treatment works (POTW or wastewater treatment plant). The monitoring data and observations during the test period for field test sewer system 10 demonstrates that the treatments systems 100 according to preferred embodiments of the invention and a preferred method of using such treatment systems 100 are effective at reducing odor (H₂S) and eliminated most FOG accumulation.

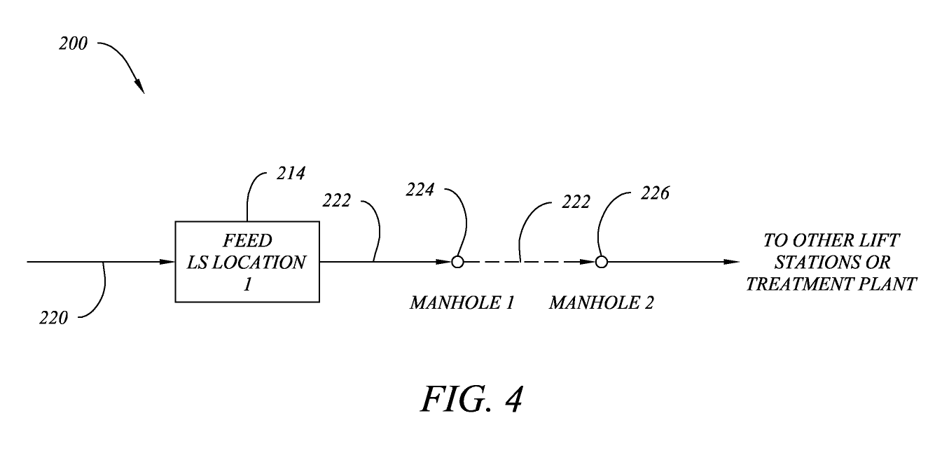

A system and method according to a preferred embodiment of the invention were field tested in another municipal sewer system to control odor (H₂S) and Fats, Oil and Grease (FOG) accumulation. FIG. 4 shows a schematic of the sewer system 200 as used in this field test, which was a 1 million gallon per day (MGD) flow system that was segmented into a forced main (shown by solid flow line in FIG. 4) followed by a gravity feed section (shown by dotted flow line in FIG. 4). Given the larger flow in this second system 200, a larger biogenerator (such as a biogenerator 124) was used to seed the system. This larger system dosed 250 gallons of bacterial suspension at 10⁶ CFU/ml to a lift station 214 upstream of the POTW. Alternatively, multiple biogenerators could have also been used to achieve a large volume of bacteria suspension to feed lift station 214. Disposed inside lift station 214 was also a small aerator/mixer (another commercially available Little John model). Untreated wastewater 220 fed into lift station 214 and treated wastewater 222 was discharged from lift station 214. Manholes 224 and 226 were located downstream of lift station 214. The representation of the field test sewer system 200 in FIG. 4 shows only a portion of the overall sewer system that was treated with a treatment system 100 according to a preferred embodiment of the invention.

The field test sewer system 200 was monitored downstream at the second manhole 226. This monitoring location provided the net efficacy on both forced main and gravity fed streams. An odalogger H₂S monitoring device (one type of monitoring system 128 that may be used) was placed inside the sewer system and suspended from manhole 226. This field test was run in three phases. Phase A had both the biogenerator and the aerator/mixer running in lift station 214 for five weeks, while Phase B had just the biogenerator running. Phase C had both units off and was used to establish a period of no treatment that could be used as a baseline, where the baseline was determined three weeks after turning the units off, and was a two week average that followed the three week transition period. The baseline data was used to calculate the % H₂S reduction during the earlier two phases.

Tables 2-3 shows the results for the 5 weeks of Phase A and 5 weeks of Phase B treating. The temperatures were similar in Phase A and B, so it was concluded that temperature would not have been a major differentiator during this study. The results from Table 2 show an average 94% reduction in H₂S during the Phase A when the biogenerator and aerator/mixer were running and the results in Table 3 show a 91% reduction when only the biogenerator was running during Phase B. This data again shows the benefits of using a treatment system 100 according to a preferred embodiment of the invention and further shows that the biogenerator by itself may be sufficient for good H₂S reduction, but that the combination of the biogenerator and aerator/mixer provided slightly better performance.

TABLE 2
Test Manhole Date Phase A

| | % H₂S | Temperature |
|---|---|---|
| WEEK | Reduction | ° F. |
| 1A | 96.4 | 81 |
| 2A | 94.5 | 81 |
| 3A | 93.6 | 83 |
| 4A | 94.8 | 81 |
| 5A | 92.9 | 83 |
| Average | 94.4 | 82 |
| Range | 3.5 | 2 |

TABLE 3
Test Manhole Date Phase B

| | % H₂S | Temperature |
|---|---|---|
| WEEK | Reduction | ° F. |
| 1B | 92.5 | 87 |
| 2B | 93.1 | 88 |
| 3B | 89.8 | 88 |
| 4B | 90.7 | 86 |
| 5B | 90.6 | 82 |
| Average | 91.3 | 86 |
| Range | 3.3 | 6 |

Those of ordinary skill in the art will also appreciate upon reading this specification and the description of preferred embodiments herein that modifications and alterations to the device may be made within the scope of the invention and it is intended that the scope of the invention disclosed herein be limited only by the broadest interpretation of the appended claims to which the inventors are legally entitled.

We claim:

1. A system for treating a wastewater network comprising:
a biogenerator for generating a bacteria solution, wherein the biogenerator is configured to periodically receive starter bacteria and water via gravity feed, to grow bacteria in a solution for a period of time, and to periodically discharge the bacteria solution into wastewater within the wastewater network by gravity feed; and
a monitoring system for monitoring parameters of the wastewater.

2. The system according to claim 1 wherein the wastewater network is a municipal sewer system comprising a plurality of lift stations;
wherein a first lift station has high levels of H₂S or grease cap formation;
wherein the biogenerator discharges the bacteria solution into a second lift station located upstream of the first lift station; and wherein the monitoring system is located at or downstream of the first lift station.

3. The system according to claim 1 further comprising a controller connected to the biogenerator, wherein the controller is configured to automatically adjust operating parameters for the biogenerator based on a timing mechanism, or data or signals received from the monitoring system, or to receive manual inputs to adjust operating parameters for the biogenerator based on the monitored parameters of the wastewater.

4. The system according to claim 2 further comprising an aerator for adding oxygen into the wastewater in the second lift station.

5. The system according to claim 3 further comprising an aerator for adding oxygen into the wastewater in the second lift station and wherein the controller is connected to the aerator and is configured to automatically adjust operating parameters for the aerator based on a timing mechanism, or data or signals received from the monitoring system, or to receive manual inputs to adjust operating parameters for the aerator based on the monitored parameters of the wastewater.

6. The system according to claim 4 comprising a plurality of biogenerators; wherein a first biogenerator discharges the bacteria solution to the second lift station and one or more other biogenerators discharges the bacteria solution into one or more other lift stations located upstream from the first lift station.

7. The system according to claim 2 wherein the monitoring system tests the wastewater for one or more of the following parameters: H₂S level, dissolved oxygen level, and corrosion rate.

8. The system according to claim 1 further comprising a chemical feed system for feeding chemicals into the wastewater.

9. The system according to claim 4 further comprising a mixer located within the second lift station to agitate the wastewater.

10. The system according to claim 1 wherein the water received by the biogenerator is from a source external to the wastewater network.

11. The system according to claim 10 wherein the water is from a municipal water supply.

12. The system according to claim 6 wherein the first biogenerator discharges a first bacteria solution comprising one or more species of bacteria and wherein at least one of the other biogenerators discharges a second bacteria solution comprising one or more bacteria species that are different from the species in the first bacteria solution.

13. The system according to claim 6 wherein a volume of wastewater that flows through the second lift station and one or more other lift stations located upstream from the first lift station is at least 50% of the total volume of wastewater in the wastewater network.

14. The system according to claim 6 wherein one or more of the lift stations receiving the bacteria solution from one of the biogenerators discharges wastewater into a forced main.

15. The system according to claim 6 comprising a plurality of aerators; wherein each aerator is located at a lift station where one of the biogenerators discharges the bacteria solution.

16. A method of treating a wastewater network comprising the steps of:
generating bacteria in a biogenerator;
feeding the bacteria into wastewater within the wastewater network via gravity feed; and
monitoring one or more parameters of the wastewater.

17. The method according to claim 16 wherein the wastewater network is a municipal sewer system comprising a plurality of lift stations;
wherein a first lift station has high levels of H₂S or grease cap formation;
wherein the bacteria is fed into a second lift station located upstream of the first lift station; and
wherein the wastewater is monitored at or downstream of the first lift station.

18. The method according to claim 16 further comprising a controlling operating parameters for the biogenerator, wherein such controlling is carried out by a timing mechanism, or automatically by a controller based on data or signals received from the monitoring step, or is carried out based on manual inputs into the controller based on the parameters of the wastewater determined by the monitoring step.

19. The system according to claim 16 further comprising aerating the wastewater in the second lift station with an aerator to add oxygen into the wastewater.

20. The system according to claim 18 further comprising aerating the wastewater in the second lift station and controlling operating parameters for the aerator, wherein such controlling is carried out by a timing mechanism, or automatically by a controller based on data or signals received from the monitoring step, or is carried out based on manual inputs into the controller based on the parameters of the wastewater determined by the monitoring step.

21. The method according to claim 19 comprising generating bacteria in a plurality of biogenerators;
feeding bacteria from a first biogenerator into the second lift station; and
feeding bacteria from one or more other biogenerators into one or more other lift stations located upstream from the first lift station.

22. The method according to claim 17 wherein the monitoring step comprises testing the wastewater for one or more of the following parameters: H2S level, dissolved oxygen level, and corrosion rate.

23. The method according to claim 16 further comprising feeding treatment chemicals into the wastewater.

24. The method according to claim 19 further comprising mixing the wastewater in the second lift station.

25. The method according to claim 16 further comprising supply the biogenerator with water from a source external to the wastewater network.

26. The method according to claim 25 wherein the water is from a municipal water supply.

27. The method according to claim 21 wherein the first biogenerator feeds a first bacteria solution comprising one or more species of bacteria and wherein at least one of the other biogenerators feeds a second bacteria solution comprising one or more bacteria species that are different from the species in the first bacteria solution.

28. The method according to claim 21 wherein a volume of wastewater that flows through the second lift station and one or more other lift stations located upstream from the first lift station is at least 50% of the total volume of wastewater in the wastewater network.

29. The method according to claim 21 further comprising discharging wastewater into a forced main from at least one of the lift stations in which the bacteria is fed.

30. The method according to claim 21 comprising a plurality of aerators for aerating the wastewater; wherein each aerator is located at a lift station in which the bacteria is fed.
